(19) United States
(12) Patent Application Publication
(10) Pub. No.: US 2013/0164507 A1
(43) Pub. Date: Jun. 27, 2013

(54) SPORTS BOARD AND METHODS FOR MANUFACTURING SAME

(71) Applicant: Aifu Shen, Ningbo (CN)

(72) Inventor: Aifu Shen, Ningbo (CN)

(21) Appl. No.: 13/725,883

(22) Filed: Dec. 21, 2012

(30) Foreign Application Priority Data
Dec. 22, 2011 (CN) 201110460726.X

(51) Int. Cl. B32B 7/12; B32B 17/06; B32B 17/04; B32B 3/10; B32B 37/02; B32B 5/24

(52) U.S. Cl. CPC B32B 7/12; B32B 37/02; B32B 5/245; B32B 17/04; B32B 3/10; B32B 17/064
USPC 428/196; 156/185; 428/319.1; 428/317.7

(57) ABSTRACT

A sports board is made by forming a rough blank that has an inner foam core and an outer cured fiberglass layer. The method further includes the steps of applying a bonding composition to the top and bottom surfaces of the rough blank; placing an upper surface panel and a lower surface panel on the top and bottom surfaces of the rough blank before the bonding composition has cured; heating the molded sports board in a compression mold; and trimming the molded sports board to form the finished sports board.

### PRIORITY CLAIM

This application claims priority to Chinese Patent No. 201110460726.X, filed Dec. 22, 2011, the subject matter of which is hereby incorporated by reference as if fully set forth herein.

### TECHNICAL FIELD

The invention relates to a sports board for sports such as skateboarding, snowboarding, waterskiing, surfing, body-boarding, and so on, and a manufacturing method thereof.

### BACKGROUND

Sports boards made from thermoplastic materials that may be used for various recreational activities such as surfing, body-boarding, skateboarding, snowboarding, waterskiing, and snow-sledding generally include a layer of plastic material on the top and bottom surfaces of the board. These layers of plastic surface material are typically laminated to a core made from foamed material. However, due to challenges faced in laminating such a high-density, non-foamed, solid sheet of plastic surface material to the bottom of a foamed core, the surface material is typically first laminated to an intermediate layer of plastic material before the surface material can be laminated to the foam core. Although this step avoids distortions caused by heating the surface material to bonding temperatures, inclusion of the additional layer can compromise the stiffness and strength of the bonds between the layers of the sports board, thereby increasing the possibility of damage during use.

### SUMMARY

In one embodiment, a sports board includes a rough blank, an upper surface panel, and a lower surface panel. The rough blank has an inner foam core and an outer cured fiberglass layer. The upper and lower surface panels are bonded to the inner foam core via a bonding composition, without an intermediate plastic layer. Bonding compositions that may be used in accordance with the embodiments described herein include epoxy resins and adhesives.

In other embodiments, methods for manufacturing a sports board, such as the boards described above, are provided. Such methods may include a series of steps to form a rough blank that has an inner foam core and an outer cured fiberglass layer, including filling a foam mold with a foamed material; heating the foamed material to a predetermined foaming temperature to form the inner foam core; cooling the inner foam core; drying the inner foam core at a predetermined drying temperature; wrapping a layer of fiberglass cloth around the inner foam core; coating the fiberglass cloth with an epoxy resin to form the outer cured fiberglass layer to form a core board; and sanding the core board to form the rough blank having a top surface and a bottom surface.

In some embodiments, the methods of manufacturing may also include steps of applying a bonding composition, which includes a second fiberglass cloth and epoxy resin. Additionally, before the epoxy resin has been cured, the upper surface panel and the lower surface panel may be placed on the top and bottom surfaces of the rough blank coated with the bonding composition to form a molded sports board. The methods also include heating the molded sports board in a compression mold at a predetermined compression mold temperature; and trimming the molded sports board to form the finished sports board.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the views:

FIG. 1 is a perspective view of a sports board according to one embodiment.

FIG. 2 is a top view of the sports board shown in FIG. 1.

FIG. 3 is a bottom view of the sports board shown in FIG. 1.

FIG. 4 is a side view of the sports board shown in FIG. 1.

FIG. 5 is a sectional view, taken along line S-S of FIG. 2.

FIG. 6 is an enlarged sectional view taken along line K-K of FIG. 2.

FIG. 7 is an enlarged view of Section I of FIG. 5.

FIG. 8 is a flowchart of a method of manufacturing a sports board according to one embodiment.

FIG. 9 is a flowchart of a method of manufacturing a sports board according to another embodiment.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

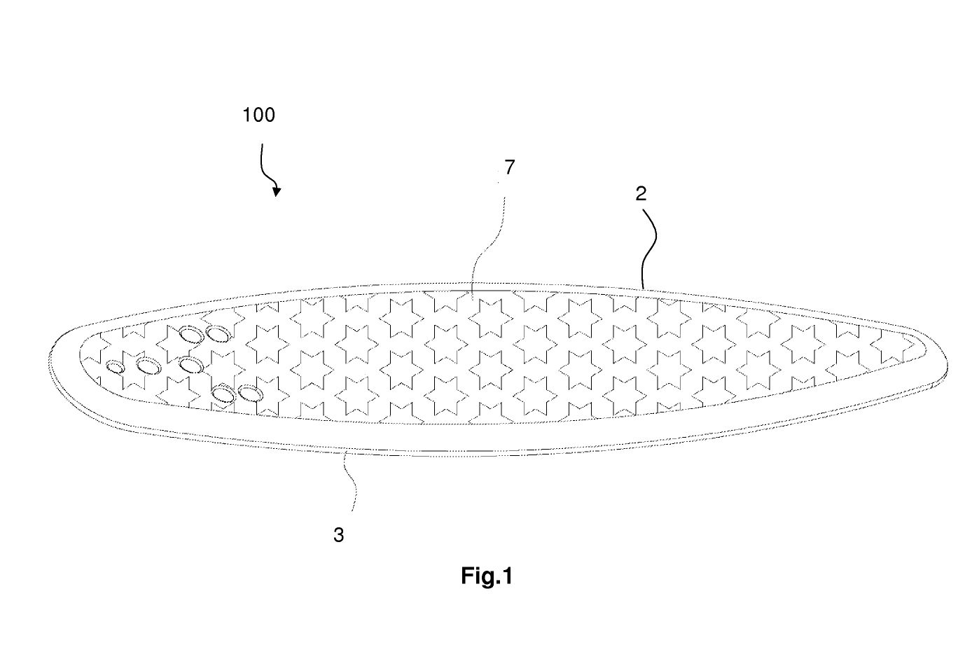

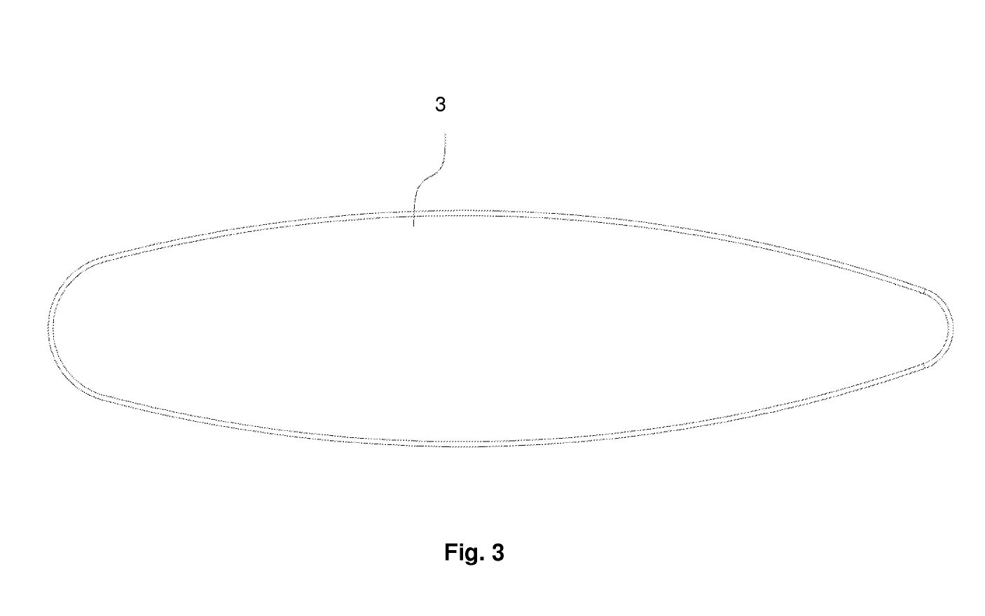

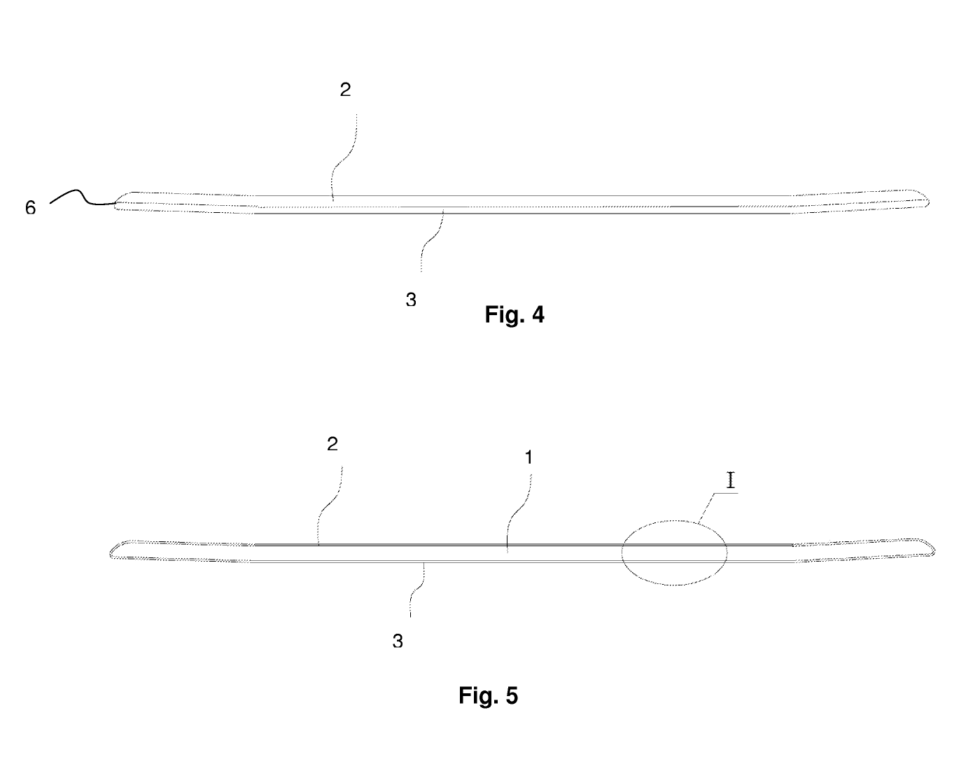

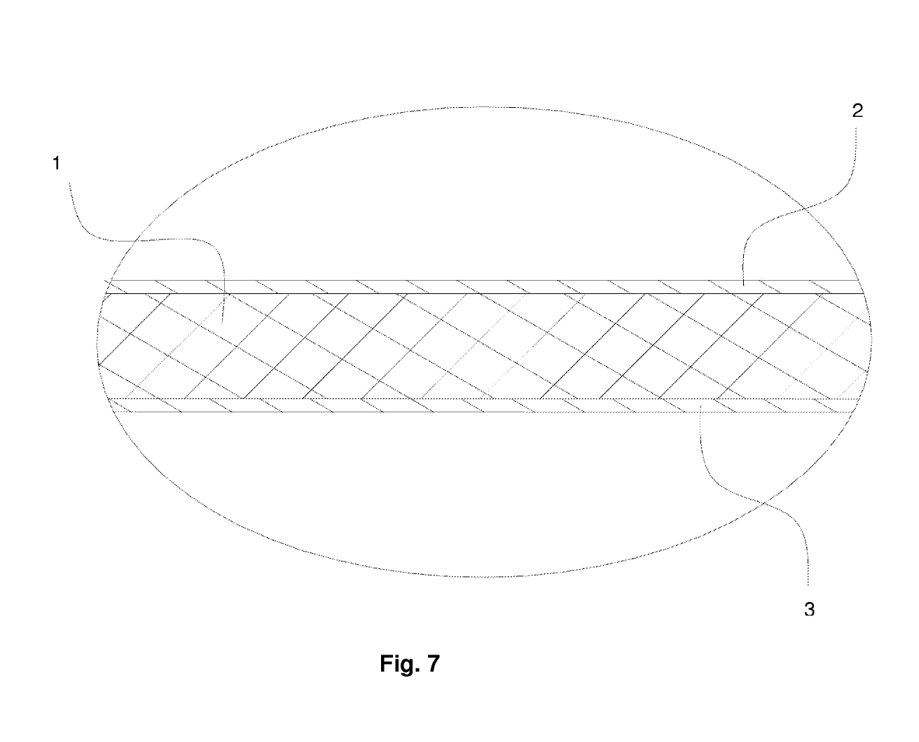

Turning now in detail to the drawings, as shown in FIGS. 1-7, a sports board 100 includes a rough blank 1 having an inner foam core and an outer cured fiberglass layer, an upper surface panel 2, and a lower surface panel 3. The inner foam core of the rough blank 1 may be molded or otherwise formed from any suitable foamed material including, but not limited to, polypropylene (PP), polystyrene (PS), expanded polystyrene (EPS), extruded polystyrene (XPS), polyurethane (PU), and polyethylene (PE). The outer cured fiberglass layer includes a glass fiber cloth (also referred to herein as a “fiberglass cloth”) and an epoxy resin that, when cured, forms the outer surface of a core board that is sanded and smoothed to form the rough blank 1. The rough blank 1 has a top surface and a bottom surface to receive a bonding composition as described further below.

The upper and lower surface panels 2, 3 each have an inner side that faces the rough blank 1 and an outer side that faces away from the rough blank 1 in a finished sports board 100. In some embodiments, the top surface of the rough blank 1 is bonded to the inner side of the upper surface panel 2 without including an intermediate plastic layer between the rough blank 1 and the upper surface panel 2. Similarly, the bottom surface of the rough blank 1 is bonded to the inner side of the lower surface panel 3 without including an intermediate plastic layer between the rough blank 1 and the upper surface panel 2. The upper surface panel 2 and the lower surface panel 3 may be bonded to the rough blank via a bonding composition that may include one or more suitable bonding agents including, but not limited to, glue, hot adhesives, and epoxy resins (e.g., bisphenol A epoxy resin, bisphenol F epoxy resin, novolac epoxy resin, aliphatic epoxy resin, and glycidylamine epoxy resin).

The upper surface panel 2 and the lower surface panel 3 may be formed from a high-density plastic sheet of a suitable thermoplastic polymer to provide enhanced stiffness including, but not limited to, polyethylene polyvinyl chloride, polyurethane, polycarbonate resin, or polyethylene terephthalate.

Omission of an intermediate plastic layer, and, consequently, bonding of the upper and/or lower surface panel 2, 3 to the rough blank 1, as described further below, is one way to enhance overall stiffness of the sports board 100. Enhanced stiffness increases performance of the sports board 100 by allowing a user to go faster, to make better turns, and to have more control. In some embodiments, the upper surface panel 2 and the lower surface panel 3 each have an outer edge that meet each other to form a seam or a joint 6 along the lateral circumference of the rough blank 1. The position of the seam or joint 6 along the lateral circumference of the rough blank 1 is at a slight upward curve, or cambered, as compared to the center of the lower and upper surface panels 2, 3. This cambered design reduces the resistance of water or snow against the sports board 100, resulting in a more smooth and controlled sliding action. In some aspects, the upper surface panel 2 may be texturized to prevent a user from slipping off the sports board 100 while riding.

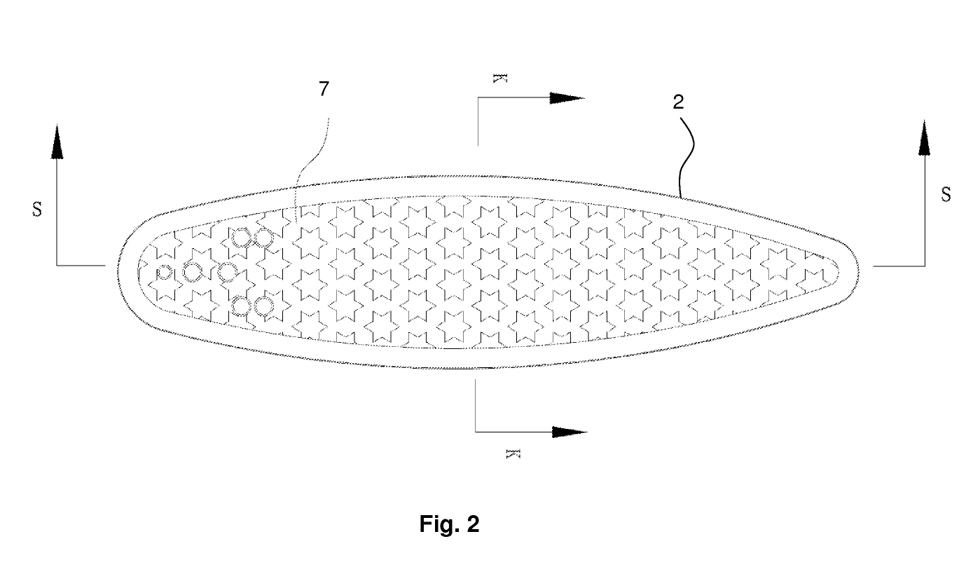

In some embodiments, the upper surface panel 2 (as shown in FIGS. 1 and 2), the lower surface panel 3, or both, may include a printed design 7 comprising one or more pictures, patterns, colors, or a combination thereof to enhance the aesthetic quality of the sports board 100. The design 7 may be printed directly on the inner or outer surface of the upper surface panel 2 or the lower surface panel 3. When the design 7 is printed on the outside surface of the upper surface panel 2 or the lower surface panel 3, a transparent protective film may be optionally be included to protect the design. In other embodiments, the design layer may be printed on the inner surface of the upper surface panel 2 or the lower surface panel 3. In this embodiment, the upper or lower surface panel 2, 3 may be made from a transparent plastic so that the pattern layer is visible through the surface panel.

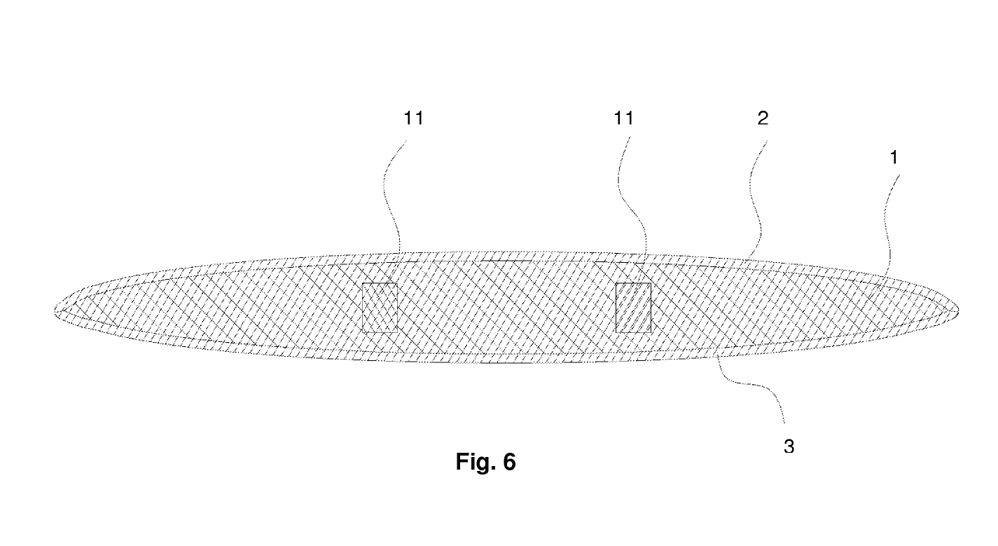

In some embodiments, one or more reinforcing ribs 11 may be embedded in the inner foam core of the rough blank 1. The reinforcing ribs 11 may be formed from any suitable material to provide increased strength to the sports board 100. As shown in FIG. 6, the reinforcing ribs 11 may be embedded at substantially regular intervals relative to each other and the ends of the sports board 100, in a parallel, axial orientation in the central region of the inner foam core.

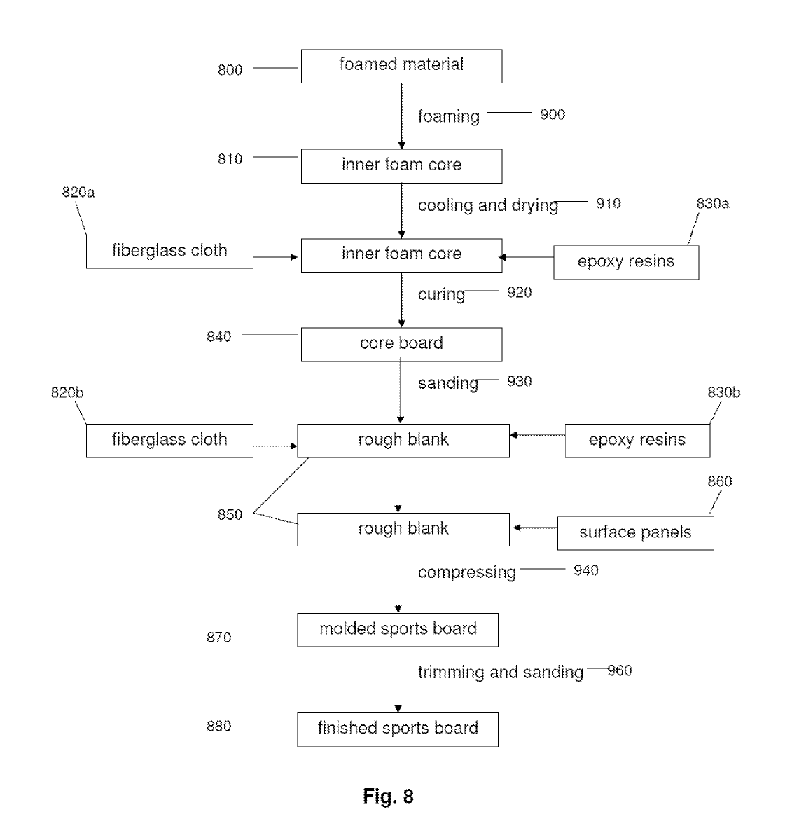

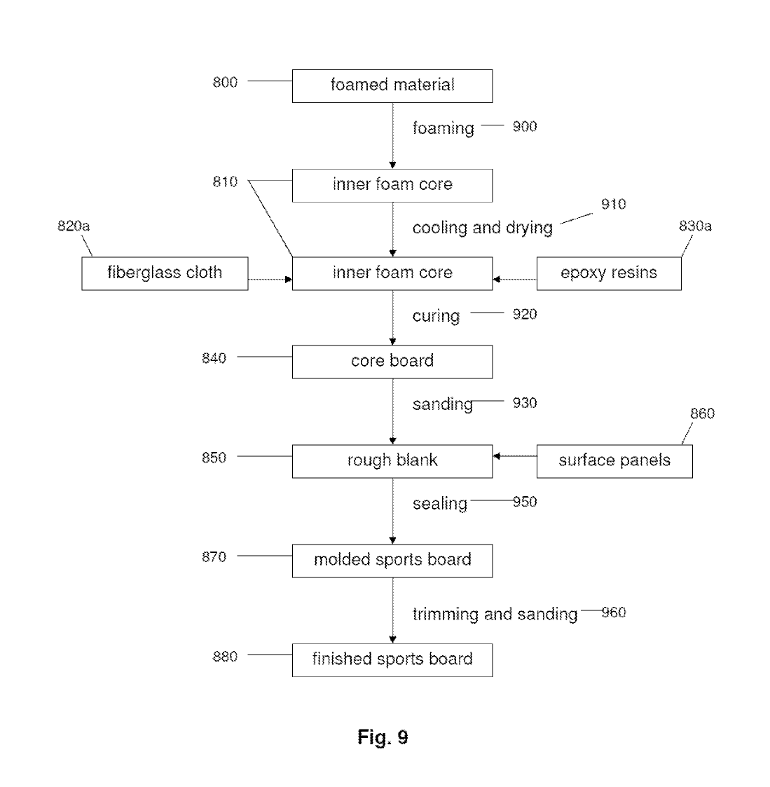

According to certain embodiments, methods for manufacturing a sports board 100, such as the boards described above, are provided herein. As illustrated in FIGS. 8-9, the methods may include a series of steps for forming a rough blank 850 having an inner foam core 810 and an outer cured fiberglass layer, which is made of fiberglass cloth 820a and epoxy resins 830a, 830b. The inner foam core 810 may be formed by any suitable foaming-mold process 900 including, but not limited to, a steam-foaming-mold process, an injection-foaming-mold process, and an expanded-bead-foam-compression molding process.

The foaming-mold process 900 may be accomplished by filling a foaming mold with a thermoplastic foamed material 800 such as PS, granular PS, PP, granular PP, EPS, XPS, PU, PE or any other suitable foamed material. The foamed material in the foaming mold is heated in a mold at a temperature of approximately 100° C. to 180° C. for approximately 2 to 5 minutes to form the inner foam core 810 of the rough blank 850. In some embodiments, the foamed material 800 is placed in the foaming mold that is at a temperature of approximately 100° C., 140° C., or 180° C. for approximately 5, 3, or 2 minutes, respectively, to form the inner foam core 810 of the rough blank 850. After cooling 910 for approximately 2 to 5 minutes in the foaming mold using cooled water, the inner foam core is cooled to room temperature and then dried 910 in an oven or in the presence of another suitable heat source at a drying temperature of approximately 45° C. to 65° C. In some embodiments, the inner foam core may be dried 910 at a drying temperature of approximately 45° C., 55° C., or 65° C. when the foaming material 800 is placed in the steam foaming mold at a foaming temperature of approximately 100° C., 140° C. or 180° C., respectively.

After forming the inner foam core 810, a layer of fiberglass cloth 820a or other fibrous material is wrapped around the inner foam core 810 such that the surface area of the wrapped inner foam core is covered by the fiberglass cloth 820a. The fiberglass cloth 820a is then sprayed or coated with an epoxy resin 830a and cured 920 at room temperature to form the outer cured fiberglass layer of the resulting core board 840. The core board 840 is then sanded 930, forming a rough blank 850 having a top surface and a bottom surface.

According to some embodiments, the methods described herein may include applying a bonding composition to the rough blank. As illustrated in FIG. 8, the bonding composition may include a second or additional layer of fiberglass cloth 820b or other fibrous material that is wrapped around the rough blank 850 such that the surface area of the wrapped rough blank 850 is covered by the fiberglass cloth 820b. The fiberglass cloth 820b is then sprayed or coated with an epoxy resin 830b to form an upper coated surface and a lower coated surface of rough blank 850. Before the resin is cured, the upper surface panel and the lower surface panel (collectively, “surface panels”) 860 are placed on the upper coated surface and the lower coated surface of the rough blank 850 such that the outer edges of the upper and lower surface panels 860 meet to form a seam or a joint 6. Placing the surface panels on the rough blank is advantageous because the additional layer of fiberglass imparts an increased hardness and stiffness, while also serving as an adhesive for the outer surface area, thereby obviating the need to laminate the layers together. Such a method also provides an efficient, one-step integration of the outer surface layer and the rough blank. The rough blank 850, which is bonded to upper and lower surface panels 860, is then subjected to a suitable heat-molding process to form the molded sports board 100.

The heat-molding process may be any suitable process including, but not limited to, a compression-molding process or a vacuum-molding process. In one embodiment, the molded sports board is formed by a compression-molding process 940, which may include steps of placing the rough blank 850 bonded to upper and lower surface panels 860 in a mold, and compressing 940 the materials in a molding press at a temperature of 50° C. to 130° C. for approximately 5 to 30 minutes to form the molded sports board 870. In some embodiments, the molded sports board 870 may be formed by compressing 940 the materials in a molding press at a temperature of 50° C., 90° C., or 130° C. when the rough blank 850 and the upper and lower surface panels 860 are compressed 940 in the mold for approximately 30, 15, or 5 minutes, respectively, to form the molded sports board 870. After cooling, the surface panel is removed from the mold, trimmed, and sanded 960 to form the finished sports board 880.

In other embodiments, as shown in FIG. 9, the bonding composition may include an adhesive, such as glue, a hot adhesive, or another suitable adhesive. As such, the methods described herein may include a step of applying an adhesive to the rough blank 850, or to the inner sides of the upper and lower surface layers 860, or both. The upper and lower surface layers 860 are then positioned on the top surface and bottom surface of the rough blank 850, respectively, to bond them to the rough blank 850.

The upper and lower surface panels 2, 3 are then sealed 950 to each other at their outer edges to form a seam or a joint 6 along the lateral circumference of the rough blank 850 to form the molded sports board 870. In some embodiments, the upper and lower surface panels 860 are sealed 950 to each other by a heat-sealing process, an ultrasonic or high-frequency-sealing process, or any other suitable sealing process. In one embodiment, a high-frequency sealer, which uses high frequency or ultrasonic vibrations to join thermoplastic materials, is used to seal the upper and lower surface panels 860. The molded sports board 870 is then trimmed and sanded 960 to form the finished sports board 880.

Sports boards manufactured without an intermediate plastic layer, as described herein, are generally firmer and stiffer than conventional sports boards while also being lightweight and durable. Further, the sports boards are relatively easy to manufacture, do not require complicated equipment to manufacture the sports boards, and may be efficiently produced in high yield.

Any of the above-described embodiments may be used alone or in combination with one another. Furthermore, the sports board and methods of manufacturing may include additional features not described herein. While several embodiments have been shown and described, various changes and substitutions may of course be made, without departing from the spirit and scope of the invention. The invention, therefore, should not be limited, except by the following claims and their equivalents.

What is claimed is:

1. A sports board, comprising:
a rough blank, the rough blank having an inner foam core and an outer cured fiberglass layer;
an upper surface panel bonded to a top surface of the rough blank without an intermediate plastic layer; and
a lower surface panel bonded to a bottom surface of the rough blank without an intermediate plastic layer.

2. The sports board of claim 1, wherein the rough blank is bonded to the upper surface panel and the lower surface panel via a bonding composition.

3. The sports board of claim 2, wherein the bonding composition comprises an adhesive.

4. The sports board of claim 2, wherein the bonding composition comprises an epoxy resin.

5. The sports board of claim 1, wherein the upper surface panel is printed with a design comprising at least one picture, pattern, or color.

6. The thermoformed sports board of claim 1, wherein the lower surface panel is printed with a design comprising at least one picture, pattern, or color.

7. The sports board of claim 1, wherein the inner foam core comprises polystyrene, expanded polystyrene, polypropylene, or polyurethane.

8. The thermoformed sports board of claim 1, wherein the upper surface panel and the lower surface panel each comprise a sheet of polyethylene, polyvinyl chloride, polyurethane, polycarbonate resin, or polyethylene terephthalate.

9. A method for manufacturing a sports board, comprising the steps of:
(a) forming a rough blank having an inner foam core and an outer cured fiberglass layer by a method comprising the steps of:
filling a mold with a foamed material;
heating the mold to a predetermined temperature to form the inner foam core;
cooling the inner foam core;
drying the inner foam core at a predetermined drying temperature;
wrapping a layer of first fiberglass cloth around the inner foam core;
coating the first fiberglass cloth with an epoxy resin to form the outer cured fiberglass layer of a core board; and
sanding the core board to form the rough blank having a top surface and a bottom surface;
(b) applying a bonding composition to the top surface and the bottom surface of the rough blank, the bonding composition comprising a second fiberglass cloth and an epoxy resin;
(c) placing the upper surface panel and the lower surface panel on the top and bottom surfaces of the rough blank, respectively, which are coated with the bonding composition, to form a molded sports board;
(d) heating the molded sports board in a compression mold at a predetermined temperature; and
(e) trimming the molded sports board to form a finished sports board.

10. The method of claim 9, wherein the foamed material comprises polystyrene, expanded polystyrene, polypropylene, or polyurethane.

11. The method of claim 9, wherein the upper surface panel and the lower surface panel each comprise a sheet of polyethylene, polyvinyl chloride, polyurethane, polycarbonate resin, or polyethylene terephthalate.

12. The method of claim 9, wherein the foamed material is heated for approximately 2 to 5 minutes at a temperature of 100° C. to 180° C.

13. The method of claim 9, wherein the predetermined drying temperature is approximately 45° C. to 65° C.

14. The method of claim 9, wherein the molded sports board is heated for approximately 5 to 30 minutes at a predetermined temperature of 50° C. to 130° C.

15. A method for manufacturing a sports board, comprising the steps of:
(a) forming a rough blank having an inner foam core and an outer cured fiberglass layer by a method comprising the steps of:
filling a mold with a foamed material;
heating the mold to a predetermined temperature to form the inner foam core;
cooling the inner foam core;
drying the inner foam core at a predetermined drying temperature;
wrapping a layer of fiberglass cloth around the inner foam core;
coating the fiberglass cloth with an epoxy resin to form the outer cured fiberglass layer to form a core board; and
sanding the core board to form the rough blank having a top surface and a bottom surface;
(b) applying an adhesive to at least one of the rough blank and the upper and lower surface panels;
(c) placing the upper surface panel and the lower surface panel on the top surface and the bottom surface of the rough blank; and
(e) trimming the molded sports board to form a finished sports board.

16. The method of claim 15, wherein the thermoplastic foamed material comprises polystyrene, expanded polystyrene, polypropylene, or polyurethane.

17. The method of claim 15, wherein the upper surface panel and the lower surface panel each comprise a sheet of polyethylene, polyvinyl chloride, polyurethane, polycarbonate resin, or polyethylene terephthalate.

18. The method of claim 15, wherein the foamed material is heated for approximately 2 to 5 minutes at a predetermined foaming temperature of 100° C. to 180° C.

19. The method of claim 15, wherein the predetermined drying temperature is approximately 45° C. to 65° C.
